(19) United States
(12) Patent Application Publication
(10) Pub. No.: US 2023/0222927 A1
(43) Pub. Date: Jul. 13, 2023

(54) QUANTITATIVE APPROACH AND DEPARTURE RISK ASSESSMENT SYSTEM

(71) Applicant: VIRGINIA TECH INTELLECTUAL PROPERTIES, INC., Blacksburg, VA (US)

(72) Inventors: Bradley Scott GOBIN, Carlisle, PA (US); Robert Clayton BRIGGS, Blacksburg, VA (US); Thomas JONES, Blacksburg, VA (US); Robert A. CANFIELD, Blacksburg, VA (US)

(21) Appl. No.: 18/000,730

(22) PCT Filed: Jul. 20, 2021
(86) PCT No.: PCT/US2021/042348

§ 371 Date: Dec. 5, 2022

Related U.S. Application Data
(60) Provisional application No. 63/053,955, filed on Jul. 20, 2020.

(51) Int. Cl. G08G 5/00; G01C 21/20

(52) U.S. Cl. CPC G08G 5/0056; G01C 21/20; G08G 5/0091; G08G 5/003; G08G 5/0069

(57) ABSTRACT

Various embodiments of a system and method for a quantitative approach and departure risk assessment are described. In one example, the system includes program instructions executable in the computing device that, when executed by the computing device, cause the computing device to: obtain a nominal flight path of an aircraft, calculate a potential crash area for a section of the nominal flight path based on a failure mode, calculate risk values based on a population data of a geographical area traveled corresponding to the nominal flight path, and display the calculated risk values plotted on a map of at least a section of the geographical area traveled corresponding to the nominal flight path. Other examples include corresponding computer systems, apparatus, and computer programs recorded on one or more computer storage devices, each configured to perform the actions of the methods.

### CROSS-REFERENCE TO RELATED APPLICATION

This application claims the benefit of and priority to U.S. Provisional Application No. 63/053,955, titled “QUANTITATIVE APPROACH AND DEPARTURE RISK ASSESSMENT TOOL,” filed on Jul. 20, 2020, the entire contents of which are hereby incorporated herein by reference.

### FEDERALLY SPONSORED RESEARCH STATEMENT

This invention was made with government support under agreement No. N00421-16-2-0001 awarded by the Naval Air Systems Command (NAVAIR). The government has certain rights in the invention.

### BACKGROUND

The flight path of aircraft can traverse a variety of terrains and populated areas. The flight path can be planned or adjusted depending on the use. In the event of equipment failure, other failure, or termination of flight the aircraft, it is helpful to have knowledge of the potential ground risk for a given flight. An aircraft can be controlled by a human pilot on board or can be operated remotely via a communications system for an unmanned aerial system.

### SUMMARY

A quantitative approach and departure risk assessment system is described. In one example, the quantitative approach and departure risk assessment system can include a computing device and program instructions executable in the computing device. The computing device can include at least one hardware processor. The system can include program instructions executable in the computing device that, when executed by the computing device, cause the computing device to: obtain a nominal flight path of an aircraft, calculate a potential crash area for a section of the nominal flight path based on a failure mode, calculate a risk value based on population data of a geographical area traveled corresponding to the nominal flight path, and display the calculated risk value plotted on a map of at least a section of the geographical area traveled corresponding to the nominal flight path. Implementations of the described techniques may include hardware, a method or process, or computer software on a computer-accessible medium.

In some cases, the section of the nominal flight path can include one section of a plurality of sections, the nominal flight path connects at least two sequential waypoints, and the nominal flight path is divided into the plurality of sections based on each population cell traversed along the nominal flight path. The computing device can be further configured to cause the computing device to sum the risk values for each population cell along the nominal flight path. The section of the nominal flight path can include a length of a distance traveled across a population cell defined in the population data, and the potential crash area is based on a failure point along the nominal flight path at an entry point of the population cell.

The computing device can be further configured to calculate the risk value based on a probability of loss of an aircraft, where the probability of loss of the aircraft is adjusted for a time spent over the population cell for the section of the nominal flight path. The computing device can be further configured to calculate the risk value based on truncated gaussian probability distribution applied to the potential crash area. The computing device can be further configured to calculate the risk value based on a joint probability distribution, the joint probability distribution may include an along-track distribution colinear to the section of the nominal flight path and an across-track distribution perpendicular to the section of nominal flight path. The computing device can be further configured to calculate the risk value based on a bivariate joint distribution a function of radial and angular coordinates.

In some cases, the aircraft can be a fixed wing aircraft or a rotorcraft, and where the failure mode is selected from at least one of: fixed wing flight termination, fixed wing glide and dive, rotorcraft flight termination, rotorcraft dive, and rotorcraft autorotation. The computing device can be further configured to receive input may include at least one of: lift-to drag ratio, velocity, and altitude at failure. To calculate the potential crash area, the computing device can be further configured to determine impact points based on maximum distances the aircraft could travel in all directions. To calculate the potential crash area, the computing device can be further configured to determine a geometry of a turn and a straight flight descent. To calculate the potential crash area, the computing device can be further configured to use a time delay before the turn and the straight flight descent. To calculate the potential crash area, the computing device can be further configured to use wind speed and wind direction.

In another example, a non-transitory computer-readable medium embodying program code executable in a computing device is described. The non-transitory computer-readable medium embodying program code can include program instructions configured to cause the computing device to at least obtain a nominal flight path of an aircraft, calculate a potential crash area for a section of the nominal flight path based on a failure mode, calculate risk values based on a population data of a geographical area traveled corresponding to the nominal flight path, and display the calculated risk values plotted on a map of at least a section of the geographical area traveled corresponding to the nominal flight path.

In another example, a method of determining risk values for a quantitative approach and departure risk assessment is described. The method can include obtaining, in at least one computing device, a nominal flight path of an aircraft. The method can include calculating, in at least one computing device, a potential crash area for a section of the nominal flight path based on a failure mode. The method can include calculating, in at least one computing device, risk values based on a population data of a geographical area traveled corresponding to the nominal flight path. The method also includes displaying, using at least one computing device, calculated risk values plotted on a map of at least a section of the geographical area traveled corresponding to the nominal flight path.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates a computing environment according to various embodiments described herein.

FIGS. 2A and 2B illustrate examples of a potential crash area (PCA) and a hazard area over flight path according to various embodiments described herein.

FIGS. 3A and 3B illustrate examples of fixed wing lethal crash areas (LCAs) according to various embodiments described herein.

FIGS. 4A-4C illustrate examples of the descent trajectory showing different views according to various embodiments described herein.

FIGS. 5A-5D illustrate examples of a PCA definition from QUADRA tool of a Cessna 172 from an initial height above ground at 100 ft, 200 ft, 300 ft, and 500 ft according to various embodiments described herein.

FIG. 6 illustrates an example of a comparison of FTS PCA and Glide/Dive PCA for a Cessna 172 at 500 ft above ground level according to various embodiments described herein.

FIG. 7 illustrates an example of a crosswind effect on the Glide/Dive PCA for a Cessna 172 at 500 ft above ground level according to various embodiments described herein.

FIG. 8 illustrates an example of all rotorcraft PCAs shown for a notional rotorcraft at 500 ft altitude with a 10 knot headwind according to various embodiments described herein.

FIG. 9 illustrates an example of a population cell to show failure point selection according to various embodiments described herein.

FIG. 10 illustrates an example of PCA boundary to define area to extract population data according to various embodiments described herein.

FIG. 11 illustrates an example of a Gaussian normal distribution according to various embodiments described herein.

FIG. 12 illustrates an example of a normal distribution according to various embodiments described herein.

FIG. 13 illustrates an example of the joint probability distribution inside a PCA according to various embodiments described herein.

FIG. 14 illustrates an example of a radial/angular joint probability distribution according to various embodiments described herein.

FIG. 15 illustrates an example method of determining risk values for a quantitative approach and departure risk assessment according to various embodiments described herein.

FIG. 16 illustrates an example of a user interface for data entry according to various embodiments described herein.

FIG. 17 illustrates an example of a user interface for flight path entry according to various embodiments described herein.

FIG. 18 illustrates an example of a graphical results display according to various embodiments described herein.

FIG. 19 illustrates an example of a risk value results and lethal crash areas displayed in a table according to various embodiments described herein.

### DETAILED DESCRIPTION

In the context described above, various examples of Quantitative Approach and Departure Risk Assessment (QUADRA) systems and methods are disclosed herein. The QUADRA system provides an assessment of the risk to third parties on the ground should a crash of aircraft occur, with a focus on the approach and departure phase of the flight. This includes accurately determining all possible crash areas and the resulting lethal crash footprint for all portions of the flight, determining the exposed population and calculating the total risk. If needed, flight path can be modified or optimized to determine a flight path with acceptable risk values. The examples provided herein are directed to unmanned aerial systems (UAS), also known as unmanned aerial vehicles, unmanned aircrafts, or drones, but the concepts may also be relied upon for manned aircraft or aerial vehicles with a pilot on board.

The embodiments described herein include a focus on the approach and departure phase of the flight to assess the risk to third parties on the ground should a crash of an aircraft occur. The system utilizes data of the environment where the flight is occurring, as well as aircraft specific data to determine where a crash could potentially occur, the probability of the crash occurring at that location, and the expected severity of the damage. The quantitative risk values generated by the system assist a user in determining acceptable flight paths to expand the operational area of the aircraft. For example, a hazard area and risk values over a flight path can be provided in a graphical representation for evaluation. The waypoints of the flight path can be modified to determine an acceptable flight path with lower risk values. In another example, an optimal flight path can be determined by generating a flight path of least risk for any given mission.

In this context, a potential crash area is defined as an area where a crash is possible to occur following a failure at a given waypoint of the flight path. A hazard area is defined as a total area over the flight path where a crash is possible to occur, which includes the sum of all potential crash areas. Thus, a severity of risk to third parties on the ground within the geographical boundaries of the hazard area of interest can also be generated based on at least population data of the corresponding hazard area. The embodiments also include a description of the method of assessment developed as part of the QUADRA system, including computer implemented methods.

Various embodiments of systems and methods for a quantitative approach and departure risk assessment are described. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for providing a quantitative assessment of risk to third parties on the ground should a crash of an aircraft occur. The system can include a computing device including at least one hardware processor. The system also includes program instructions executable in the computing device that, when executed by the computing device, cause the computing device to: obtain a nominal flight path of an aircraft, calculate a potential crash area for a section of the nominal flight path based on a failure mode, calculate the crash footprint within the potential crash area for various failure modes, calculate risk values based on a population data of a geographical area traveled corresponding to the nominal flight path, and display the calculated risk values plotted on a map of at least a section of the geographical area traveled corresponding to the nominal flight path. Other embodiments of this aspect include corresponding computer systems, apparatus, and computer programs recorded on one or more computer storage devices, each configured to perform the actions of the methods.

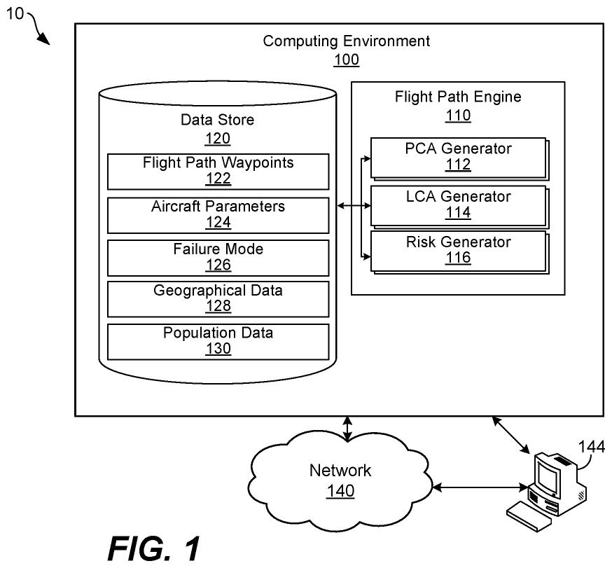

FIG. 1 illustrates an example of a computer environment 100 for the QUADRA system. The computing environment 100 can be embodied as one or more computers, computing devices, or computing systems. In certain embodiments, the computing environment 100 can include one or more computing devices arranged, for example, in one or more server or computer banks. The computing device or devices can be located at a single installation site or distributed among different geographical locations. The computing environment 100 can include a plurality of computing devices that together embody a hosted computing resource, a grid computing resource, or other distributed computing arrangement, managed as a software-defined data center (SDDC). Thus, the computing environment 100 can be embodied as an elastic computing resource where an allotted capacity of processing, network, storage, or other computing-related resources varies over time. As further described below, the computing environment 100 can also be embodied, in part, as certain functional or logical (e.g., computer readable instruction) elements or modules as described herein.

The computing environment 100 can operate as a QUADRA system. In some embodiments, the computing environment 100 can be included in a networked computing environment. In that context, the computing environment 100 includes data store 120 and flight path engine 110. The flight path engine 110 includes a potential crash area (PCA) generator 112, a lethal crash area (LCA) generator 114, and risk value generator 116. The PCA generator 112, LCA generator 114, and risk value generator 116 can be embodied as applications executing on the computing environment 100. The PCA generator 112, LCA generator 114, and risk value generator 116 are described in further detail below. In some embodiments, a client device 144 having a user interface can access the computing environment directly. In some embodiments, a client device 144 can access the computing environment via a network 140. In some embodiments, one or more of the databases of data store 120 can be located in a remote computing environment and accessed via the network 140.

The data store 120 can be embodied as a medium to store data and includes memory areas for the storage of flight path waypoints 122, aircraft parameters 124, and failure modes 126, among other types of data. Additionally, the data store 120 can include memory areas for the storage geographical data 128 and population data 130. The data store 120 can store data in the form of relational databases, object-oriented databases, hierarchical databases, hash tables or similar key-value data stores, as well as other data structures. Data store 120 can included one or more databases stored locally or in a remote computing environment. For example, data store 120 can reside in the computing environment 100. In an example, the geographical data 128 and population data 130 can include licensed or publicly accessible data. The databases can include data sets compiled by the user. For example, the QUADRA system can be configured to utilize a data set for a geographical region surrounding a particular airport, city, or region of interest. The flight path waypoints 122, aircraft parameters 124, failure modes 126, geographical data 128, and population data 130 are associated with the functional components and operations of the computing environment 100, as described below.

For example, flight path waypoints 122, aircraft parameters 124, and failure modes 126 can be provided as user input and stored for later retrieval. Flight path waypoints 122 can include least two waypoints for a nominal flight path. Each waypoint can include latitude, longitude, and altitude. The flight path waypoint data 122 can also include speed and flight termination time. The aircraft parameters 124, can include wingspan, weight, lift to drag ratio, maximum bank angle, thrust, glide speed, FTS radius, drag coefficient, and cross-sectional area. In some examples, the environmental parameters can also be obtained, including windspeed and wind direction. The failure modes data 126 correspond to the type of aircraft, such as fixed wing or rotorcraft. For example, the failure modes data 126 can include parameters related to fixed wing flight termination system, fixed wing glide and dive, rotorcraft flight termination system, rotorcraft dive, and rotorcraft autorotation.

For example, population data 130 for the system can be stored as a raster, which is divided into cells. Raster data can be stored as a large matrix that has columns for the latitude, longitude, and population of each cell. Storing the data in a matrix allows for easy calculations and incorporation into the QUADRA tool. For example, the cell size can be an area smaller a typical census tract data, providing a significantly finer population data. Smaller population cell areas can better define population that each individual LCA is interacting with, as opposed to using an average over a large area.

With finer population and potential crash area models used in QUADRA, the risk to the population along the flight path can be determined by population cell by cell. The risk equation can be configured to include additional factors to gain insight into the risk, such as probability of crash within a potential crash area. This takes into consideration that within a potential crash area, the probability of a crash occurring is not uniform. The finer population model also allows for the addition of building data to evaluate how sheltered the population is for a given area. Summing the risk for a cell by cell method allows for an accurate and granular risk calculation. The finer population data allows QUADRA to treat the population density as non-uniform and give an accurate assessment as to what population is actually at risk. The finer population model also allows for additional crash probability models to be incorporated to refine the risk to each individual population area.

In an example, the system can access LandScan™ for population data to calculate a risk in a specified area. LandScan™ generates its population maps through combining government censuses, satellite imagery, and National Databases such as National Center of Education Statistics for School time populations. LandScan™ provides population information for both the US and the entire globe, and is updated yearly. The US LandScan™ data also provides daytime and nighttime population trends to give additional insight into where people are located at any given time. For example, US LandScan™ provides population cells with an average area around 70×70 meters while the Global LandScan™ cells average 1×1 km. LandScan™ is one example of a database providing population data, but any suitable population data set for cells related to latitude and longitude can be relied upon.

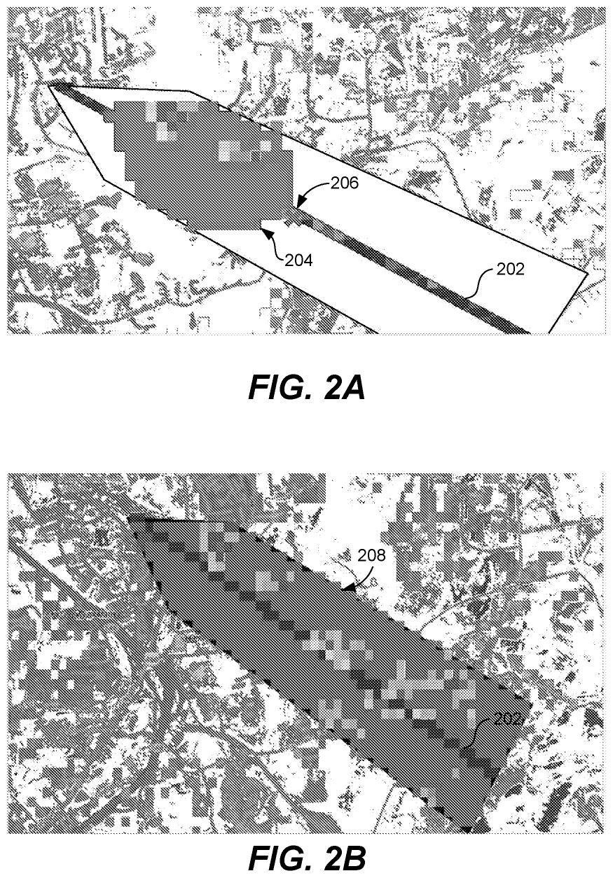

Shown in FIG. 2A is an example of a nominal flight path 202 over a geographical area. A potential crash area 204 is shown with respect to a point of failure 206. As shown in FIG. 2A, the results of risk for each individual population cell can be generated to indicate the level of risk graphically, such as with a heat map. FIG. 2B show an example of a hazard area 208 along a similar flight path. The hazard area 208 is a total area over the flight path where a crash is possible to occur, which includes the sum of all potential crash areas. Similar to FIG. 2A, the results of risk shown graphically for each individual population cell along the flight path 202.

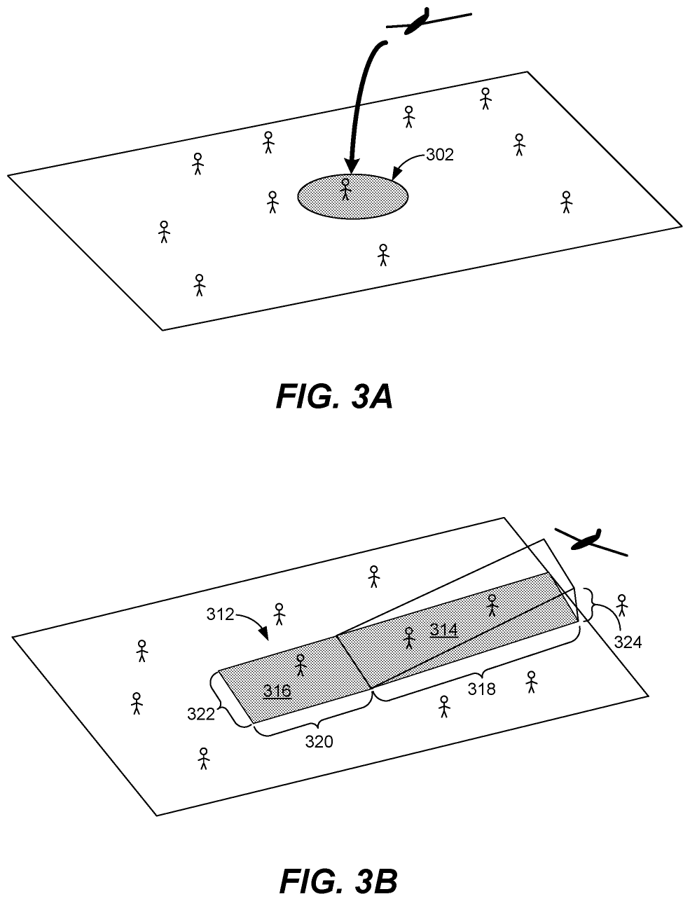

Shown in FIGS. 3A and 3B are examples of lethal crash areas for two different failure modes. Illustrated in FIG. 3A is an example dive LCA 302 for a fixed wing dive is shown. In this example, the aircraft dives at a velocity and the LCA 302 is related to the aircraft wingspan and radius of a person. Illustrated in FIG. 3B is an example glide LCA 312 for a fixed wing glide is shown. In this example, the glide LCA 312 includes two parts, the glide portion 314 and skid portion 316. The glide LCA 312 is related to the aircraft wingspan, length of the glide 318, and length of skid 320. The threshold for impact is based on a height of an average person. The glide LCA 312 comprises an area that is the width of the aircraft wingspan 322 and length of the glide 314, from the height of threshold impact 324 to ground, and length of the skid 320 to resting position.

In an example, QUADRA can use four unique potential crash areas, each with a different size and shape depending on the failure mode that occurred. This allows the user to tune the analysis to focus on the particular failures that are expected or desired for testing. Further, by graphically showing the level of risk with a heat map for each individual population cell, the high and low risk areas can be evaluated to assist in flight path planning to avoid higher risk areas.

The potential crash area (PCA) and lethal crash area (LCA) are dependent on the specific failure mode. QUADRA allows the user to specify the probability of different failure modes to account for the differences in the PCA and LCA. Different failure modes can be considered for fixed wing aircraft and rotorcraft. For example, the failure modes for fixed wing aircraft can include Flight Termination System (FTS), Glide/Dive, unpowered stable glide, loss of flight control, in flight breakup, controlled ditch without power, fireball, powered uncontrolled, and stable flight (i.e. fly away). The failure modes for rotorcraft can include FTS, unpowered and/or uncontrolled descent, autorotation descent, in flight breakup, controlled ditch without power, fireball, powered uncontrolled, and stable flight (i.e. fly away).

For fixed wing aircraft, examples of Flight Termination System (FTS) and the combination glide/dive failure modes are described herein. For example, the hazard area for an FTS failure mode can be determined using the Clothier method with FTS time limit. Similarly, the hazard area for a combination glide/dive failure mode can be determined using the Clothier method glide range limit. Other failure modes for fixed wing aircraft can be determined by setting modifying parameters and/or using additional methods including the Sensis method and crash dynamic model. For example, determining a hazard area for a controlled ditch without power failure mode may be similar to an unpowered stable glide with preferences set for an unpopulated area.

For rotorcraft, examples of FTS, unpowered and/or uncontrolled descent, and a limited rotorcraft autorotation failure mode are described herein. For example, the hazard area for an FTS failure mode can be determined using the Clothier method with FTS time limit, but with no turn component. In an example, the hazard area for unpowered and/or uncontrolled descent can be determined by projectile motion with optional drag effects. For an autorotation failure mode, a very limited model based on fixed wing glide and be used for a simple determination of hazard area. The autorotation failure mode can be extended to include additional parameters for a more accurate determination of hazard area. Similarly, determining a hazard area for a controlled ditch without power failure mode may be similar to the autorotation failure mode with preferences set for an unpopulated area. Other failure modes for rotorcraft can be determined by setting modifying parameters and/or using additional methods including the crash dynamic model.

An approach for defining the Potential Crash Area for failure modes will be explained in more detail herein. For example, the PCA generator 112 can determine a potential crash area based on one or more failure modes. The failure mode can correspond to the type of aircraft being a fixed wing aircraft or a rotorcraft. For example, the failure modes can include fixed wing flight termination system and fixed wing glide and dive. For example, the failure modes can include rotorcraft flight termination system, rotorcraft dive, and rotorcraft autorotation. Additionally, the PCA generator 112 can determine the hazard area over the flight path by summing a plurality of PCAs.

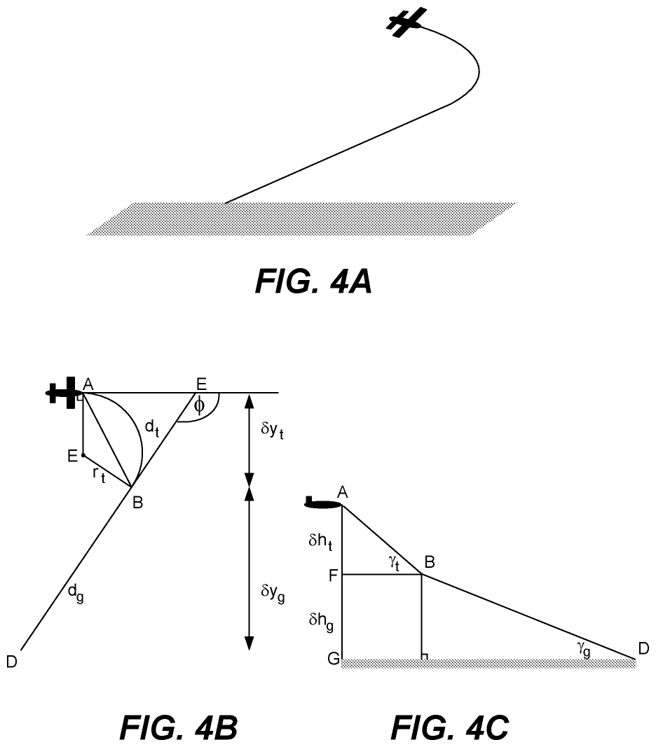

Most of the PCA calculations implemented can utilize a modified Clothier method for determining the impact location. To determine a PCA for a glide, Clothier separated the gliding flight into two portions, a turn to a new heading and the glide after the turn. The resulting flight path is illustrated in FIGS. 4A-4C. The flight path is based on the glide range (which is a function of the initial altitude and flight path angle), the turn radius of the aircraft and the angle of turn.

Shown in FIG. 4A is an illustration of a descent trajectory shown in a 3D view showing a turn to a new heading and the glide after the turn. In FIG. 4B, a top-down view of the descent trajectory in FIG. 4A is illustrated. The positions at the initial altitude and end of the turn are labeled A and B, respectively. The turn angle co, turn radius of rₜ, and turn diameter dₜ are identified. The glide distance d_{g} is defined from the end of the turn B to the ground D. Accordingly, the altitude drop of the turn δhₜ and altitude drop of the glide δh_{g} are labeled accordingly. Similarly, FIG. 4C illustrates a side view of the descent trajectory in FIG. 4A.

In an example, the hazard area can be determined using the following steps. To determine the distance of glide the flight path angle (γ) is needed, which can be found by taking the inverse of the lift-to-drag ratio. Since the bounds of the PCA should be the maximum distance possible, the maximum lift-to-drag ratio can be used to calculate the minimum flight path angle and maximum glide distance:

$${γ}_{min} = \frac{1}{{( L / D )}_{max}} \qquad ( 1 )$$

$${d}_{max} = \frac{alt}{tan ( {γ}_{min} )} \approx \frac{alt}{{γ}_{min}} \qquad ( 2 )$$

The max glide distance (dₘₐₓ) represented the case where the aircraft does not turn during the glide. To determine the distance traveled if there is a turn, the turn radius can be calculated as:

$${r}_{t} = \frac{{V}^{2}}{ℊ tan μ} \qquad ( 3 )$$

where μ is the bank angle, V is the aircraft velocity and g is the gravitational constant. Using this radius, the distance traveled and altitude drop during the turn can be calculated:

dₜ=ϕrₜ (4)

δhₜ=dₜ tan γₜ≈dₜγₜ (5)

where φ is the turn angle and γₜ is the flight path angle during the turn. Based on previous studies the best glide after the turn is achieved when the bank angle is set to 45 degrees. This results in the following relationship between the flight path angle during glide and the turn:

γₜ=1.5γ_{g}=1.5γₘᵢₙ (6)

After calculating the turn parameters, the distance of the straight glide after the turn can be found as:

$${d}_{ℊ} = \frac{alt - δ {h}_{t}}{tan {γ}_{ℊ}} \approx \frac{alt - δ {h}_{t}}{{γ}_{ℊ}} \qquad ( 7 )$$

From this Clothier then derived an ellipsoid model based off maximum distances the aircraft could travel in all directions. However, for the QUADRA tool the impact point can be iterated over turn angles (φ) to calculate an exact hazard area.

The PCA generator 112 can determine a potential crash area based on one or more failure modes. For example, these calculations can be used to determine impact points for the glide/dive failure mode for a fixed wing aircraft. The glide/dive PCA outer edge is defined by the maximum glide range of the aircraft. The resulting polygon contains all points from the current aircraft position out to this max glide range.

The calculations to determine an impact point can be iterated over all turn angles to find impact points for all possible aircraft turn angles. The turn angles used for this iteration are 270 to −270 degrees, with negative turns representing a right turn. Initially these limits were set to 360 degrees to fully capture all possible turns, however at higher crosswind conditions this resulted in an overly complex PCA shape. It was determined that 270 degrees captures most of the possible turns and limits any issues with edge cases.

Special consideration can be given to end criteria for lower altitudes, where not all turn angles are possible. This can prevent the resulting PCA from intersecting itself and further limits the turn angles. The iteration of overturn angles is stopped if the altitude lost during the turn maneuver is greater than the initial altitude or the given turn direction crosses the curve formed by the opposite turn direction.

When the altitude lost during the turn maneuver is greater than the initial altitude, the aircraft will impact the ground before the turn can be completed and the current turn angle is the limit for the given turn direction. If this is true, a point is added at the origin (initial aircraft location) to complete the PCA polygon.

When the given turn direction crosses the curve formed by the opposite turn direction, the PCA polygon has cross itself. To form a single polygon the iteration is stopped and the points are set to connect the two curves. As the altitude of the aircraft is increased, the resulting PCA changes shape from a “pie slice” shape to an ellipse.

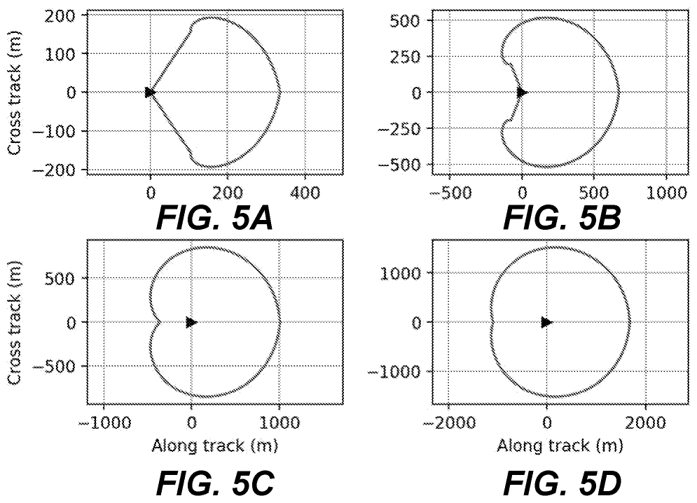

In an example, to verify this method, the results of this calculation were compared to a 6 degree-of-freedom (6-DOF) simulation of a Cessna 172 performed by Clothier. Commonly available statistics of the Cessna 172 were used as input values, as shown in Table 1. Using these input parameters, a Glide/Dive PCA was calculated using QUADRA for a starting altitude of 100 ft, 200 ft, 300 ft, and 500 ft, with results shown in FIGS. 5A-5D, respectively. Comparing the results from the QUADRA tool to those from the 6-DOF simulation, the slight differences in the shapes of the areas, most pronounced for the 300 ft altitude (FIG. 5C), are due to the different end criteria utilized and likely some variation in the input values.

TABLE 1
Input Values used for Cessna 172 test case

| | |
|---|---|
| Max Lift-to-Drag Ratio | 11 |
| Glide Velocity | 65 knots (110 ft/s) |
| Bank Angle during Turn | 45 deg |
| Gravitational Constant | 32.1741 ft/s² |
| Wind | No wind (0 knots) |

When implemented in the system, the PCA generator 112 can generate a PCA for fixed wing Glide/Dive failure mode. For example, a tuple of x and y points of PCA, referenced to flight path and failure location, can be based on user input, including: lift-to-drag ratio, glide velocity, gravitational constant, initial altitude, wind speed, and wind direction glide velocity, gravitational constant.

The PCA generator 112 can determine a potential crash area based on one or more failure modes. In another example, the fixed wing flight termination system (FTS) PCA is based on an estimated time between the point of the failure to the activation of the FTS system. This is an input to the QUADRA tool and is normally determined based of the reaction time of the pilot in command (PIC). The method used to calculate the PCA for FTS is very similar to the Glide/Dive as it uses a Clothier method of determining the geometry of the turn and the straight flight. However, unlike the Glide/Dive, the end criteria for this method is the distance the aircraft flies in the allowed FTS time. This means the resulting PCA does not vary with altitude.

The time required to execute a turn with a certain turn angle is found as

$${t}_{turn} = \frac{ϕ {r}_{t}}{V} \qquad ( 8 )$$

After the turn the time left for straight flight is found by subtracting the turn time from the FTS time. A distance flown during this straight portion of flight can be found as below.

t_{straight}=t_{FTS}−tₜᵤᵣₙ (9)

d_{straight}=Vtₜᵤᵣₙ+r_{FTS} (10)

where r_{FTS} is the radius of the FTS maneuver. This accounts for the dynamics of the aircraft after the FTS initialization. This is an input value to the QUADRA tool.

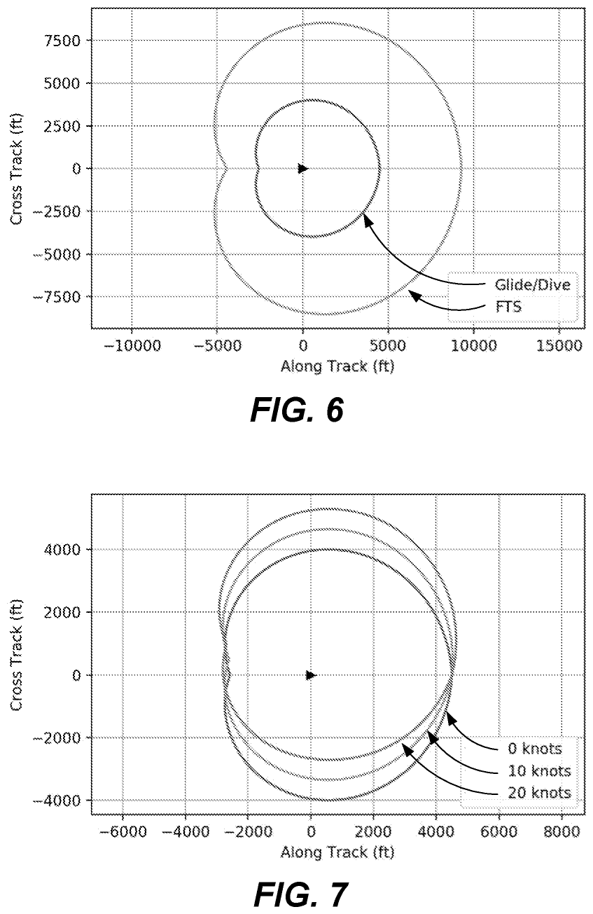

Similar to the Glide/Dive method, these calculations are iterated through the different turn angles. The iteration is stopped if the turn time exceeds the FTS time or if the two curves (left and right turn) cross each other. A graph of the FTS PCA compared to the Glide/Dive PCA is shown in FIG. 6.

The preceding calculations did not consider any effect of wind. Wind affects the ground track that the aircraft follows for both the turn and the straight flight portion. For the turn, the ground track is determined by utilizing a geometrical model of the turn based on a turn along a trochoid and straight element that change according to wind speed and wind direction.

For a given turn angle (φ) the final position of the aircraft relative to the starting position can be calculated as

$$x = {x}_{0} + {r}_{t} cos ( α + ϕ ) + {r}_{t} \frac{{V}_{wind , x}}{V} ( α + ϕ ) \qquad ( 11 )$$

$$y = {y}_{0} + {r}_{t} sin ( α + ϕ ) + {r}_{t} \frac{{V}_{wind , y}}{V} ( α + ϕ ) \qquad ( 12 )$$

The start angle (α) is the initial position on the trochoid. The start angle is fixed to −90° and 90° for left and right turns, respectively, and x₀ and y₀ specify the position of the trochoid in space, which can be found by setting x and y to 0 when φ=0. The above equations can then be solved for x₀ and y₀.

For the straight flight portion the calculation of the ground track and impact point is simply the range calculated in a no-wind condition, combined with the contribution of the head/tail wind along the flight path. This assumes that the aircraft turns to a heading and maintains the flight path, adjusting for any crosswinds. These adjustments for wind were added into all PCA calculations. FIG. 7 shows the effect of a crosswind of varying speeds on the Glide/Dive PCA, where the wind is from the right of the flight path.

When implemented in the system, the PCA generator 112 can generate a PCA for fixed wing FTS failure mode. For example, a tuple of x and y points of PCA, referenced to flight path and failure location, can be based on user input, including: velocity, gravitational constant, initial altitude, FTS time, maximum bank angle, radius of FTS maneuver, wind speed, and wind direction.

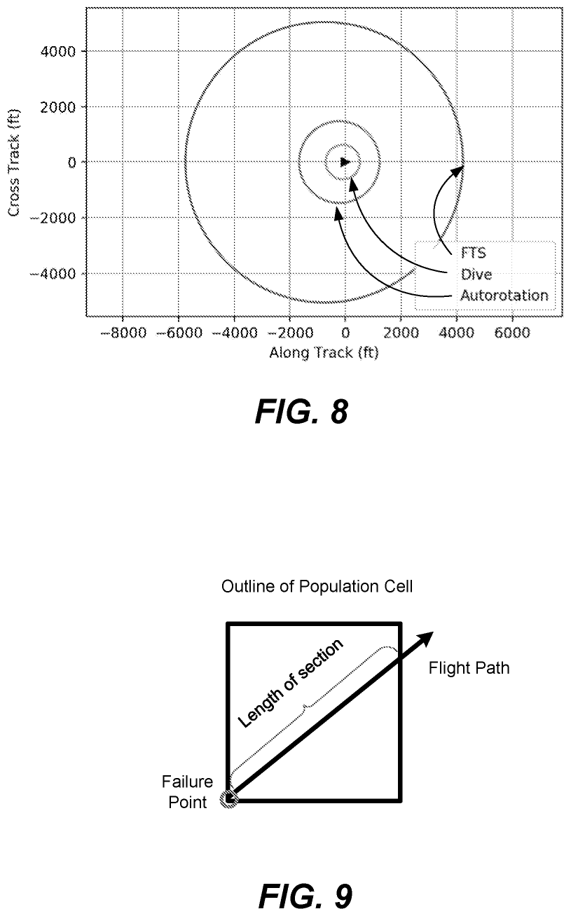

The PCA generator 112 can determine a potential crash area based on one or more failure modes for a rotorcraft. For example, to adapt the FTS PCA to rotorcraft, the turn component of the fixed wing FTS PCA can be removed. Instead, it can be assumed that the rotorcraft can instantaneously maneuver in any direction at a set velocity (normally the cruise speed). While there would be some sort of turn radius or delay in changing flight direction, this assumption results in a conservative PCA. Mathematically this results in t_{straight} being equal to t_{FTS}. The resulting PCA for FTS in a rotorcraft is circular, if there is no wind, as shown in FIG. 8.

When implemented in the system, the PCA generator 112 can generate a PCA for rotorcraft FTS failure mode. For example, a tuple of x and y points of PCA, referenced to flight path and failure location, can be based on user input including: velocity, gravitational constant, initial altitude, FTS time, radius of FTS maneuver, wind speed, and wind direction.

For autorotation of a rotorcraft, the calculations can be complex with several phases (Descent, Flare, Cushioning, etc.). In an example, a simple autorotation model can be achieved using the fixed wing Glide/Dive PCA modified in the same way as the FTS. The turn can be removed and replaced with an assumption that the rotorcraft can instantaneously maneuver to any direction. The aircraft then glides at a lift-to-drag ratio specified by the user. An example PCA for autorotation is shown in FIG. 8, with a smaller radius than the PCA determined for an FTS failure mode.

When implemented in the system, the PCA generator 112 can generate a PCA for rotorcraft autorotation failure mode. For example, a tuple of x and y points of PCA, referenced to flight path and failure location, can be based on user input including: lift-to-drag ratio, autorotation velocity, gravitational constant, initial altitude, wind speed, and wind direction.

For an unpowered and/or uncontrolled descent failure mode or unpowered diving crash, the PCA can be calculated based on projectile motion. Like the other rotorcraft failure modes, the assumption is that the rotorcraft can instantaneously maneuver to any direction. The impact location is then calculated by projectile motion with an initial horizontal velocity of V, set by the user. The only forces acting on the aircraft during this descent are the acceleration due to gravity and the drag.

When implemented in the system, the PCA generator 112 can generate a PCA for rotorcraft dive failure mode. For example, a tuple of x and y points of PCA, referenced to flight path and failure location, can be based on user input, including: velocity, gravitational constant, initial altitude, wind speed, wind direction, coefficient of drag, cross-sectional area, air density, and aircraft weight.

Since drag is a function of velocity, the impact location is found by iterating through time until the aircraft impacts the ground. For a given interval (i) the horizontal and vertical displacements can be found as

$${x}_{i} = {x}_{i - 1} + ( {V}_{x} t + \frac{1}{2} {a}_{x} {t}^{2} ) \qquad ( 13 )$$

$${y}_{i} = {y}_{i - 1} + ( {V}_{y} t + \frac{1}{2} ℊ {t}^{2} ) \qquad ( 14 )$$

where t is a given time interval and Vₓ, V_{y} and aₓ are continually updated throughout the iteration. The acceleration in the x-axis direction is found using the drag equation and Newton's second law

$$D = \frac{1}{2} ρ {V}_{x}^{2} {c}_{d} S \qquad ( 15 )$$

$${a}_{x} = \frac{D ℊ}{W} \qquad ( 16 )$$

where D is the drag, ρ is the air density, c_{d} is the drag coefficient, S is the frontal area, and W is the weight. Using these calculations, the distance traversed during the descent can be calculated to find the PCA. FIG. 8 shows a comparison of the unpowered dive PCA compared to FTS and autorotation.

From the waypoints the user specifies, a flight path is created by constructing a line that connects two sequential waypoints. This flight path is defined as the nominal flight path, or the path the aircraft would take if no failures were to occur. This nominal flight path is then divided up into sections with each section having the length of the distance traveled across the population cells. An illustration of the length of the sections is shown in FIG. 9.

The starting point of each new divided section is defined as the failure point. From this failure point, the PCA is constructed as outlined in the preceding sections. Using the short distance between each failure point, QUADRA is able to run the maximum number of failure scenarios to take advantage of the fine resolution of the LandScan™ population data. Using this failure point along with the angle of the flight, the PCA can be shifted and rotated to align with the desired flight path.

The LCA generator 114 can determine a lethal crash area, which is dependent on the failure mode. A mapping of failure mode to LCA is shown in Table 2. In general, the glide LCA is much larger and thus higher risk than the dive LCA.

TABLE 2
Failure Mode to LCA Mapping

| Failure Mode | LCA Definition |
|---|---|
| Fixed Wing FTS | Fixed Wing Dive |
| Fixed Wing Glide/Dive | Combination Fixed |
| | Wing Glide/Dive |
| Rotorcraft FTS | Rotorcraft Dive |
| Rotorcraft Dive | Rotorcraft Dive |
| Rotorcraft Autorotation | Rotorcraft Glide |

For the fixed wing Glide/Dive failure mode a combination approach of glide and dive LCA is used. Utilizing only a glide LCA would result in an overly conservative risk estimate and using only a dive LCA would result in an inaccurate low risk estimate. To achieve a more accurate risk assessment a projectile dive distance is calculated in much the same way as the rotorcraft dive PCA. Then when calculating the LCA for a given point within the PCA the QUADRA tool will select the LCA definition to use based on this projectile distance. If the distance between the current point and the origin (location of the aircraft at failure) is less than the projectile distance, then the dive LCA is used; otherwise, the glide LCA is used.

The LCA for a fixed wing dive was based on the approach used by the third-party risk assessment tool (3PRAT), although the use of other assessment tools can be relied upon. The LCA is defined as a circular area with a radius equal to half the wingspan plus the radius of the average person. The LCA can be determined as:

$${LCA}_{fixed , dive} = {π ( \frac{b}{2} + {r}_{person} )}^{2} \qquad ( 17 )$$

where b is the aircraft wingspan and rₚₑᵣₛₒₙ is the radius of the 95^{th} percentile male. For example, rₚₑᵣₛₒₙ can be 1.5 feet.

The LCA for a fixed wing glide was based on the method previously used by 3PRAT. The glide LCA include two parts, the glide portion and skid portion.

The LCA can be calculated as:

LCA_{fixed,glide}=(L_{glide}+L_{skid})×W_{Haz} (18)

The width of the hazard area is calculated from the wingspan of the aircraft and a buffer on either side of the aircraft. The buffer (d_{buffer}) is a user defined input but is notionally 10 feet.

W_{Haz}=b+2d_{buffer} (19)

The length of the glide portion of the LCA is determined based on the lift-to-drag ratio of the aircraft and the height of the 95^{th} percentile male. For example, the hₚₑᵣₛₒₙ can be 6.23 feet.

L_{glide}=hₚₑᵣₛₒₙ(L/D) (20)

The length of the skid portion of the LCA can be input by the user. For example, the skid distance is based on evaluations done on manned aircraft incidents. Table 3 lists the mean skid distances identified in the 3PRAT report.

TABLE 3
Aircraft Mean Skid Distances

| | Aircraft Category | | | | | | |
|---|---|---|---|---|---|---|---|
| | | | | Military Aviation | | | |
| | Commercial | General | | Large Aircraft | | Small Aircraft | |
| | Aviation | Aviation | Helicoptors | Takeoff | Landing | Takeoff | Landing |
| Mean Skid | 1,440 | 60 | 0 | 780 | 368 | 246 | 447 |
| Distance | | | | | | | |
| (ft.) | | | | | | | |

For a rotorcraft, the rotorcraft dive LCA is defined as a circular area with a radius equal rotor radius plus the radius of the average person. In addition, per the 3PRAT method, a recommended 10% buffer is added to account for different rotorcraft configuration. The LCA can be determined as:

$${LCA}_{rotor , dive} = 1.1 \times [ {π ( \frac{{d}_{rotor}}{2} + {r}_{person} )}^{2} ] \qquad ( 21 )$$

For a multirotor aircraft the diameter of the rotor (dᵣₒₜₒᵣ) should be set to the maximum propeller tip-to-tip dimension.

In an example, the rotorcraft glide LCA is defined in the same way as the fixed wing glide. The only difference is a 10% buffer added to the width of the hazard area.

W_{Haz}=1.1×dᵣₒₜₒᵣ+2d_{buffer} (22)

As with the autorotation PCA, this example definition is an estimation.

In the context described above, the goal of the QUADRA tool is to find the risk to third party individuals for the mission specified. A total individual risk calculation has been developed to adapt the PCA and LCA to use with population cells in a new way according to the embodiments. For example, the nominal flight path is divided into sections, with each section having the length of the distance traveled across each population cell (FIG. 9). This risk for each failure point and failure mode is found by calculating the risk of each cell, then summing the risk value across all cells in the PCA. The total risk for the mission is found by summing this risk across the entire flight path and each identified failure mode. The calculation for the total individual risk is defined as:

R=SF*P_{F}Σₖ₌₁^{l}PLOAₖΣᵢ₊₁ⁿΣⱼ₌₁^{m}D_{j,i}*ρ_{c,j,i}*A_{C,i,j,k} (23)
where: R=Individual Risk (per approach/departure)
   SF=Shelter Factor
   P_{F}=Probability of Fatality in LCA
   PLOA=Probability of Loss of Aircraft (time adjusted)
   D=Population Density
   ρ_{c}=Crash Probability Distribution
   A_{c}=Lethal Crash Area
   l=Number of Failure modes
   n=Number of PCAs/failure points along flight path
   m=Number of population cells in PCA

Shelter factor is defined as how protective the structure is that the third-party individuals are sheltered by. The default value for the shelter factor is 1, meaning that the third-party individuals are completely unsheltered and will be at risk inside of the LCA. If the shelter factor is set to 0, the individual is impervious to the aircraft crash and will not contribute to the risk. This value does not vary currently from point to point and is considered constant. The user can specify a desired shelter factor.

The probability of fatality is defined as how likely the third-party individuals hit by the aircraft will be injured and counted as a fatality. The default value is set to 1, meaning that if a person is hit by the aircraft it will result in a fatality. If the probability of fatality is set to 0, any person that is hit by the aircraft will not contribute to the risk. This value does not vary currently from point to point and is considered constant. The user can specify a desired probability of fatality.

The probability of loss of aircraft (PLOA), is defined as how likely a failure will occur per flight hour of a given aircraft. This value considers all failure modes. Since PLOA is based on time, the PLOA used in the risk calculation is scaled based upon the velocity during the flight. This scaling is done by using the length traveled over each population cell and the velocity the aircraft is traveling as it flies over that population cell. From the distance and velocity, the time spent over the cell is calculated. Using this time, the PLOA is converted into the probability that a failure will occur over that given cell along the flight path. This value varies from failure point to failure point along the flight path as the cruising velocity can change. For example, each cell traversed by the nominal flight path can have a time adjusted PLOA for the time exposure of the PCA, based on sections of the flight path. The PLOA is also scaled based upon the defined percentages for each failure. This allows the tool to accurately set a PLOA value to each failure type.

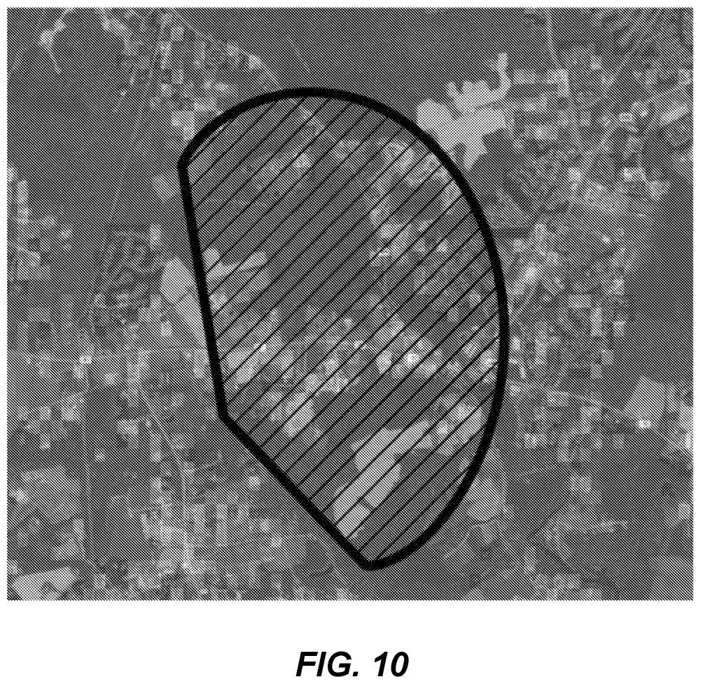

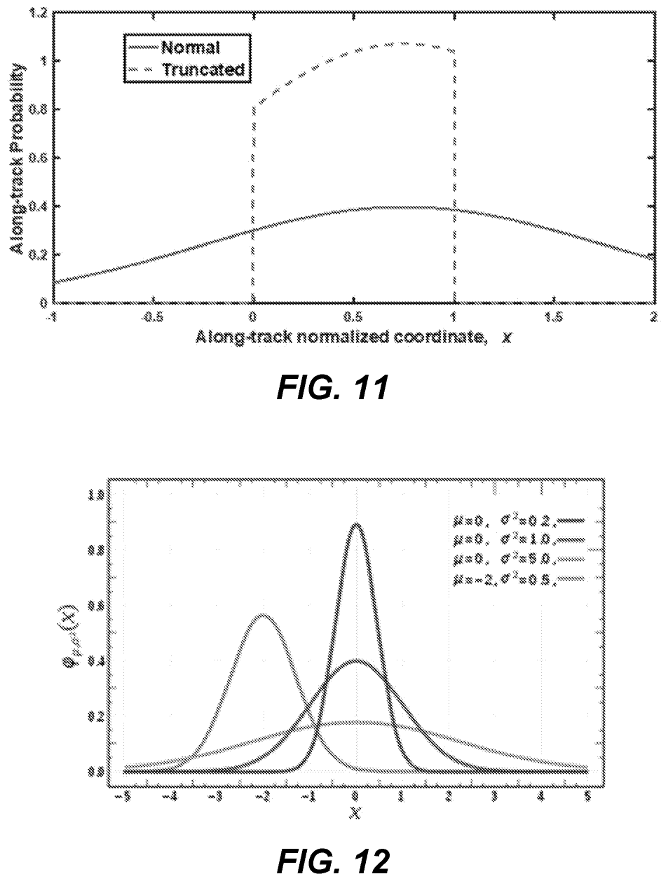

The population data is stored in a database. For each PCA calculated, the population inside of the PCA is extracted as shown in FIG. 10. Using the population value and dividing by the cell size, a population density value is calculated. This process is repeated for all the cells in the PCA, and for each PCA along the flight path.

In an example, a crash probability distribution can be determined. The crash probability distribution defines the likelihood of a crash happening in each cell in the PCA. The crash probability across the PCA is inherently not constant and varies based on several factors, including distance from the point of failure and the failure dynamics. The two probability distributions used are an “Along-Track Distribution,” which is colinear to the flight path, and a “Cross-Track Distribution,” which is perpendicular to the flight path. The user can specify the parameters of these distributions, including setting all cells to be the same probability.

The along-track distribution is defined as how likely a crash will occur as the aircraft travels along the flight path after a failure occurs. In an example, the most likely along-track direction crash point to occur can be defined as in between the mid-point between the failure and the center of the PCA polygon, for which a log-normal distribution can be used. In another example, the most likely along-track direction crash point to occur can be defined as a point between the failure point and the forward edge of the PCA polygon. This mode is defined as the location where the crashes most likely will occur, which is the mean for a Gaussian PDF, and the distribution drops as the distance from this mode point increases. In other examples, a more dynamic value based upon the aircraft used and the failure mode can be used. The probability distribution function (PDF) for along the track (x-coordinate) can be set as a truncated Gaussian (normal) distribution.

$${p}_{x} ( x ) = \frac{{e}^{- {( \frac{x - {μ}_{x}}{2 {σ}_{x}} )}^{2}}}{\sqrt{2 π} {σ}_{x} Z} \qquad ( 24 )$$

P_{AT}(x)=Probability at distance “x” from point of failure
σₓ=Standard Deviation along the track
μₓ=mean along-track normalized distance
   where μₓ=0.75 by default, along the track from the point of failure (x=0) to the furthest edge of the PCA along the track (x=1), σₓ=1 by default, and Z is the truncation factor.

Z=Φ(b)−Φ(a) (25)

where Φ(x) is the cumulative distribution function (CDF)

$$Φ ( x ) = \frac{1}{2} ( 1 + erf ( \frac{x}{\sqrt{2}} ) ) \qquad ( 26 )$$

associated with the Gaussian PDF pₓ, evaluated at the rear and forward truncation limits a and b=1, where the zero or negative value of a is determined by the most negative relative distance of the PCA behind the point of failure. The user may set the mean (mode) and standard deviation (variance or slope of the PDF) and thereby how distribution is shaped.

The values of μ and σ are set so that the mode (peak) of the distribution occurs between the failure location and the end of the PCA. This mode value is defined as the location where the crashes most likely will occur, and the distribution drops as the distance from this mode point increases. Using normal distribution's spread parameter, σ, gives the ability to change the probability distribution to drop off at different rates, depending on the conditions being tested. For example, QUADRA allows the user to set the mode and thereby how the slope of the probability distribution is shaped.

The cross-track distribution is used to quantify how likely a crash is to occur as the aircraft deviates perpendicular to the nominal flight path. For example, the most likely area for the crash to occur is along the nominal flight path, with a decreasing likelihood as the distance from the flight path increases. The probability distribution used is a symmetric truncated normal Gaussian distribution. An example is shown in FIG. 12 and described by the equation

$${p}_{y} ( y ) = \frac{{e}^{- {( \frac{y - {μ}_{y}}{2 {σ}_{y}} )}^{2}}}{\sqrt{2 π} {σ}_{y} Z} \qquad ( 27 )$$

p_{y}(y)=Probability at lateral distance “y” from flight path
σ_{y}=Standard Deviation perpendicular to the flight path
μ_{y}=mean cross-track normalized distance from the flight path
   where μ_{y}=0, as to be along the flight path, σ_{y}=0.5 by default, truncated at the extreme lateral edge of the PCA, a=−1 and b=1, for non-dimensional normalized lateral width of 2.

The user can have the ability to edit the standard deviation of this distribution to change how the probability decreases as the aircraft travels away from the flight path. FIG. 12 shows how the standard deviation changes the normal distribution. The current default standard deviation value is equal to one quarter of the lateral width of the PCA. This means that there are four standard deviations in total for the along track distribution, which was selected because 95% of the data is inside of +/−2 standard deviations and avoids very low probability tail ends of the probability. For all deviations, the probability is scaled so the sum off the probability distribution is equal to 100% and no values are missed in the calculation.

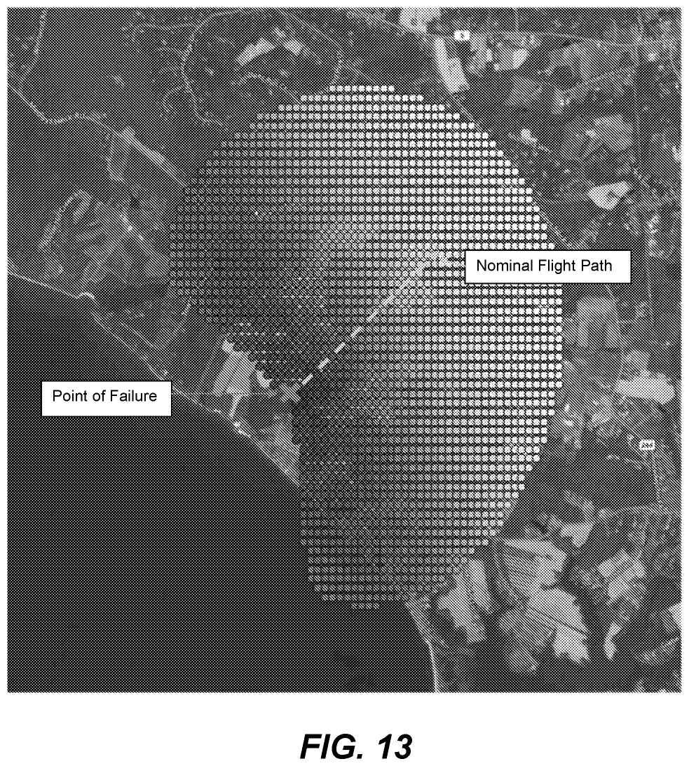

The along- and across-track distribution values are multiplied together to get the joint probability distribution. Combining the along- and cross-track distributions creates a 2-D distribution as shown in FIG. 13. This figure illustrates an example where the area ahead of the failure point has a high probability of a crash occurring, shown in a darker shade. The probability then decreases as the aircraft travels away from the failure point both along and perpendicular to the flight path. The probability distribution value changes for each PCA, and for each population cell inside of the PCA. The LCA can be determined for each cell inside of each PCA based upon the failure mode and the location within the PCA. QUADRA can calculate both the joint Gaussian PDF and a simpler uniform joint PDF as a means of quantifying the uncertainty in the assumption of PDF statistics. For example, the uniform joint PDF can use an absolute value of the distance from the mean. The truncated probability distribution functions forming a joint PDF over each segment of the flight path provides a new, innovative solution.

An alternative to Along/Cross-Track joint probability distribution is to make the bivariate joint distribution a function of radial and angular coordinates. For this option, the radial distribution is the set to be the same as the along-track PDF. The probability distribution function (PDF) for radial distance (r-coordinate) is the same truncated Gaussian (normal) distribution.

$${p}_{r} ( r ) = \frac{{e}^{- {( \frac{r - {μ}_{r}}{2 {σ}_{r}} )}^{2}}}{\sqrt{2 π} {σ}_{r} Z} \qquad ( 28 )$$

where μᵣ=μₓ is the mean along-track normalized distance, taken as μᵣ=0.75 by default, along the track from the point of failure (r=0) to the furthest edge of the PCA along the track (r=1), σᵣ is the radial standard deviation, taken as σᵣ=1 by default.

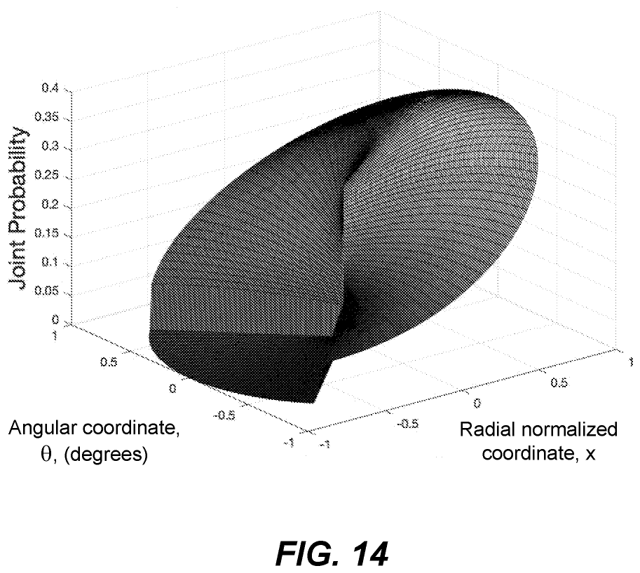

The angular distribution is used to quantify how likely a crash is to occur as the aircraft deviates from the nominal flight path. For current analysis, the most likely area for the crash to occur is along the nominal flight path, with a decreasing likelihood as the angle from the flight path increases. Again, the probability distribution used is a normal Gaussian distribution. An example is shown in FIG. 12 and described by the equation:

$${p}_{θ} ( θ ) = \frac{{e}^{- {( \frac{θ - {μ}_{θ}}{2 {σ}_{θ}} )}^{2}}}{\sqrt{2 π} {σ}_{θ} Z} \qquad ( 27 )$$

where μ_{θ}=0 is the mean angle from the flight path, σ_{θ} is the angular standard deviation in degrees from the flight path, taken as θ=75 degrees by default, truncated at the rearmost angle of the PCA, a≥−180° and b≤180°. The default joint truncated Gaussian radial/angular PDF is shown in FIG. 14.

The risk values can be calculated for each population cell inside of the determined PCA. This process is then repeated for each of the PCAs along the flight path. Once all of the risk values for the cells inside of each PCA is determined the total risk of each population cell needs to be calculated. Due to the small step sizes in between each of the PCAs, there is a large amount of population overlap that experience varying risk depending on where it falls in each unique PCA. To find the total risk to the population cell, the risk of that cell in each PCA needs to be summed. This is done by storing the risk of each cell for each PCA in a matrix composed of latitude, longitude, and risk of the cell. Once the end of the flight path is reached, the matrixes are summed up based upon matching latitude and longitude pairs. The total summed value for each cell is the total risk experience by that cell over the course of the flight. All of the total cell risk values are then added up to obtain the total individual risk for the flight path.

In an example, the calculations and methods described in herein to determine PCA, LCA, and risk evaluation were written as software functions for use in QUADRA. To check that the PCA polygon does not intersect itself, all the fixed wing PCA functions the impact points for the left turn case are calculated first, until the maximum turn angle is reached or the aircraft hits the ground. Next the right turn case is calculated. Each time a new point is calculated a check is performed. If the y-position of the right turn is greater than or equal to the y-position of the left turn, then the polygon has crossed itself. In this case the loop for the right turn is broken and the left turn curve is trimmed to match. To support this a custom lookup function was developed.

In an example, the LandScan™ population data can be easily converted into a matrix consisting of columns of the latitude, longitude, and population for risk calculations using equation 23. Columns can be appended to the matrix for each of the required values in the risk calculation. The end result is a matrix that has all of the required values and the corresponding locations that can be manipulated to calculate the risk and modify values as needed.

An example list of the functions is shown in Table 4.

| Function | Description | Inputs | Outputs |
|---|---|---|---|
| ha_glide | Calculates PCA | • Lift-to-drag ratio | • Tuple of x and y |
| | for fixed wing | • Glide velocity | points of PCA |
| | Glide/Dive | • Gravitational | (referenced |
| | | constant | to flight |
| | | • Initial Altitude | path and failure |
| | | • Wind Speed | location) |
| | | • Wind Direction | |
| ha_fts | Calculates PCA | • Velocity | • Tuple of x and y |
| | for fixed | • Gravitational | points of PCA |
| | wing FTS | constantFpy | (referenced |
| | | • Initial Altitude | to flight |
| | | • FTS time | path and failure |
| | | • Maximum | location) |
| | | Bank Angle | |
| | | • Radius of FTS | |
| | | Maneuver | |
| | | • Wind Speed | |
| | | • Wind Direction | |
| ha_fts_ | Calculates | • Velocity | • Tuple of x and y |
| rotor | PCA for | • Gravitational | points of PCA |
| | rotorcraft FTS | constant | (referenced |
| | | • Initial Altitude | to flight |
| | | • FTS time | path and failure |
| | | • Radius of FTS | location) |
| | | Maneuver | |
| | | • Wind Speed | |
| | | • Wind Direction | |
| ha_dive_ | Calculates | • Velocity | • Tuple of x and y |
| rotor | PCA for | • Gravitational | points of PCA |
| | rotorcraft dive | constant | (referenced |
| | | • Initial Altitude | to flight |
| | | • Wind Speed | path and failure |
| | | • Wind Direction | location) |
| | | • Coefficient of Drag | |
| | | • Cross-sectional area | |
| | | • Air Density | |
| | | • Aircraft weight | |
| ha_auto- | Calculates PCA | • Lift-to-drag ratio | • Tuple of x and y |
| rotation_ | for rotorcraft | • Autorotation | points of PCA |
| rotor | autorotation | velocity | (referenced |
| | | • Gravitational | to flight |
| | | constant | path and failure |
| | | • Initial Altitude | location) |
| | | • Wind Speed | |
| | | • Wind Direction | |
| cf_dive_ | Calculates Fixed | • Aircraft Wingspan | • Float value of |
| fixed | Wing Dive LCA | • Radius of Human | crash area |
| cf_ | Calculates Fixed | • Lift-to-drag ratio | • Float value of |
| glide_ | Wing Glide | • Aircraft Wingspan | crash area |
| fixed | LCA | • Height of Human | |
| | | • Length of skid | |
| | | • Lateral Buffer | |
| cf_dive_ | Calculates | • Diameter of rotor | • Float value of |
| rotor | Rotorcraft | • Radius of Human | crash area |
| | Dive LCA | | |
| cf_ | Calculates | • Lift-to-drag ratio | • Float value of |
| glide_ | Rotorcraft | • Diameter of rotor | crash area |
| rotor | Glide LCA | • Height of Human | |
| | | • Length of skid | |
| | | • Lateral Buffer | |
| y_value_ | Support function | • List of values | • Y value |
| lookup | that looks up y | formatted as [(xy)] | corresponding to |
| | value in a | • x value to be used | provided x value |
| | list for a | • Allowable margin | • Index of value |
| | given x value | for finding the | |
| | | corresponding | |
| | | x value in the list | |
| dive_ | Support function | • Velocity | • Float value of |
| distance | that determines | • Gravitational | distance traveled |
| | the projectile | constant | during projectile |
| | motion of an | • Initial Altitude | motion |
| | aircraft | • Coefficient of Drag | |
| | | • Cross-sectional area | |
| | | • Air Density | |
| | | • Aircraft weight | |
| scaling_ | Creates the | • Waypoint latitude | • Step size for |
| fact | linear | and longitude | inputs for each |
| | interpolation for | • Waypoint Altitude | sequential |
| | the user inputs | • Waypoint Velocity | waypoint |
| | to create gradual | • Waypoint | |
| | change of | FTS Time | |
| | waypoint values | | |
| Quadra- | Takes calculated | • X-Y-Z Data | • Visual plot of |
| Display | risk values and | describing | results |
| | plots results | longitude, | |
| | on map | latitude, and | |
| | | risk for each cell | |

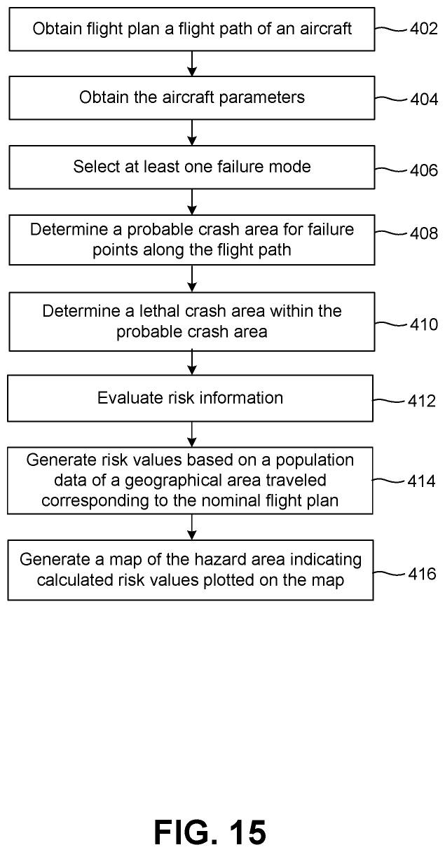

FIG. 15 shows an example method for a quantitative approach and departure risk assessment. The method can be performed by the computing environment 100 shown in FIG. 1, for example, although other computing devices can perform the method. At step 402, the method includes obtaining a flight path of an aircraft. In one example, the flight path includes at least two waypoints, although any number of waypoints can be relied upon. Each waypoint of the at least two waypoints can include location, altitude, speed, and FTS time. The location can be provided as coordinates of latitude and longitude.

At step 404, the method includes obtaining aircraft parameters. The aircraft parameters can be provided by a user via a user interface, for example, or stored beforehand. The user can choose parameters of an aircraft that has been saved in an aircraft parameter database or enter custom values. The entered values can also be saved to an aircraft parameter data base. The aircraft parameters can include wingspan, weight, lift to drag ratio, maximum bank angle, thrust, glide speed, FTS radius, drag coefficient, and cross-sectional area. In some examples, the environmental parameters can also be obtained, including windspeed and wind direction. In some examples, the population data can be selected. For example, the population data can be provided in a database. The population data can comprise population data for a specified region. For example, the region may be global or a specific to a country, such as the United States. In some examples, the population data can be provided with time of day-based distributions. For example, the population data for daytime may be different than the same geographic region at nighttime.

At step 406, the method includes selecting at least one failure mode. The at least one failure mode can correspond to the type of aircraft, wherein the type of aircraft can be fixed wing or rotorcraft. The failure modes can include fixed wing flight termination system, fixed wing glide and dive, rotorcraft flight termination system, rotorcraft dive, and rotorcraft autorotation. The failure mode can be based on input from the user including a percentage of likelihood of the type of failure mode. For example, a percentage can be selected for a dive failure, FTS failure, and/or glide failure.

At step 408, the method includes determining a potential crash area for failure points along the flight path. The potential crash area can be based on aircraft parameters and the at least one failure mode. At step 410, the method includes determining a lethal crash area within the potential crash area. This can be based on a lethal crash area for population cells for failure points along the flight path. At step 412, evaluate the risk information. The risk information can include probability of loss of aircraft, the shelter factor, and the probability of fatality. Evaluating the risk information can include determining a potential crash area for failure points along the flight path. generate risk values based on a population data of a geographical area traveled corresponding to the nominal flight path

At step 414, the method includes generating risk values based on a population data of a geographical area traveled corresponding to the nominal flight path. Risk values can be generated for each of the failure modes. A total risk can be determined by weighted values of each of the failure modes over the hazard area. At step 416, the method includes generating a map of the hazard area indicating calculated risk values plotted on the map. Generating the map can include displaying a map of the total hazard area indicating total risk by population cell. Generating the map can also include displaying the flight path and waypoints.

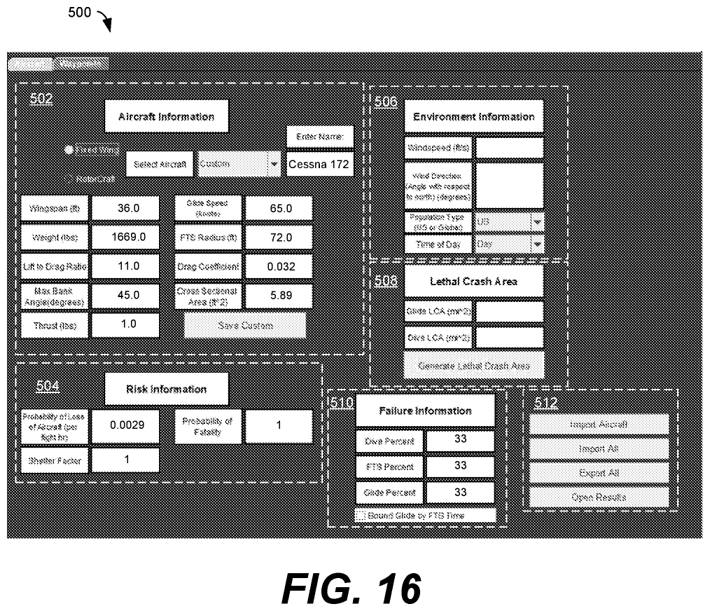

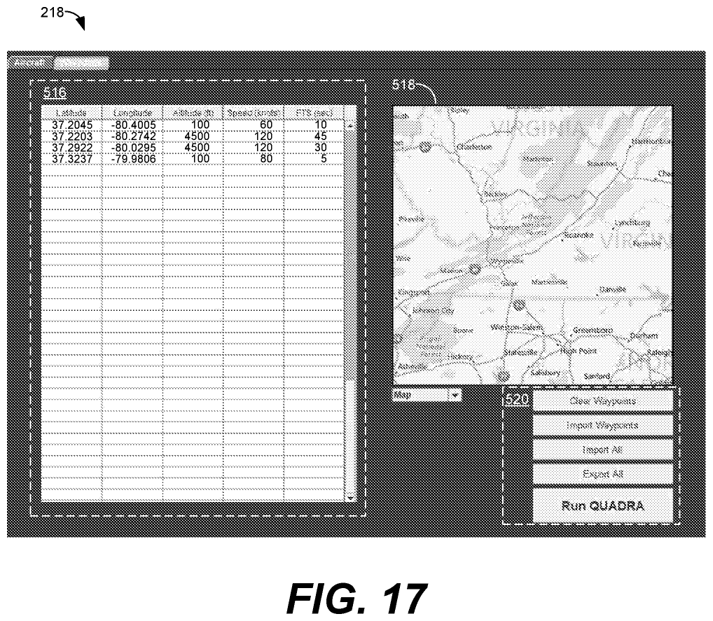

FIGS. 16-19 further illustrate an example of the QUADRA tool with examples of user interfaces and results. As can be understood, the this is one implementation and the disclosure is not limited to the specific examples shown. For example, the user interface of QUADRA can be implemented using Java in a Microsoft Windows environment, but the QUADRA method can be relied upon using other software platforms and user interfaces.

Shown in FIG. 16 is an example user interface 500 to input Aircraft Information regarding the aircraft, environmental conditions, and failure modes that are required to run the tests. For example, sections include Aircraft Information 502, Risk Information 504, Environment Information 506, Lethal Crash Area 508, and Failure Information 510. In some examples, predefined aircraft can be selected. In some examples, the aircraft information can be imported from a file. For a custom entry, the example input interface allows for a selection of fixed wing aircraft or rotorcraft with the other aircraft parameters.

In the example shown in FIG. 16, the Aircraft Information section 502 allows the user to select the aircraft properties needed to run the scenario. For example, the user can either use the drop-down menu to select a predefined aircraft or select custom to create a new aircraft. In this example, custom indicates that the aircraft information is not already stored in a database, but will be entered for the risk evaluation. The newly entered information can be saved. When custom is selected, the user must specify if the aircraft is fixed wing or rotorcraft, and then enter in all of the information in the tabs visible in the section. Any custom-made aircrafts can be named, and then saved, for example by clicking the “Save Custom” button.

In this example, the aircraft values in the Aircraft Information section 502 include: wingspan, weight, lift to drag, maximum bank angle, thrust, glide speed, FTS radius, drag coefficient, and cross-sectional area for the specified aircraft. Each of the aircraft values can affect the risk calculation. For example, an increased wingspan can increase the LCA, since there is more area that the wings of the aircraft could contact. The weight of the aircraft is used in the projectile motion calculation for the Glide and Dive failure modes. The lift to drag ratio can affect the glide crash area by defining the distance the aircraft travels in a glide while within a distance that it could come into contact with a person on the ground. The max bank angle can be used to determine how sharp of a turn the aircraft can complete after a failure occurs. Similarly, the FTS radius can be used to determine how tight of a spiral down to the ground the aircraft has after the FTS command is sent. A larger FTS radius means a looser spiral and therefore a larger PCA. The drag coefficient and cross-sectional area can be used to determine how much of an effect the wind has on shifting the PCA. The larger the drag coefficient of cross-sectional area, the higher the shifting due to the wind.

The Risk Information section 504 shown in FIG. 16 can be used for entering the probability of loss of aircraft, the shelter factor, and the probability of fatality. For example, the values for shelter factor, and probability of fatality can be set to 1 by default, unless other values are calculated. For example, the shelter factor indicates the level of shelter for the population on the ground. In this example, it is assumed to be 1, which is no shelter. A shelter factor of 0 means fully sheltered and no injury will take place. The probability of fatality indicates how likely a fatality will occur to the population in the LCA. In this example, it is assumed to be 1, which is that fatality will occur.

In the example shown in FIG. 16, the Environment Information section 506 is used to input wind speed and direction, if desired, as well as the population dataset to be used. For the wind direction, the input is in units of degrees with respect to north corresponding to the direction the wind is traveling, and shifts the PCA with respect to the wind direction. Therefore, if a wind blowing from the north to south has a wind direction of 0 degrees; a wind blowing from east to west has a wind direction of 90 degrees; and wind blowing from the south has a wind direction of 180 degrees; and a wind blowing from the west has a wind direction of 270 degrees.

In this example, US or Global data can be used for the population type to select a database with the level of detail for that area. In this example, the population type can be selected as “US” for the high resolution contiguous United States population data, or “Global” for the coarser world-wide population data set. In this example, the “US” option contains only regional information the contiguous US, while the “Global” provides data for more regions of the world. The global database can provide faster calculations but may not be as accurate due to slightly lower resolution. In some examples, if the US option is selected, the user can specify use of daytime or night-time average population distribution in the US. In this example, the level of detail for the US geography is higher, but the same concepts can be relied upon for other regions of the world by providing regional information in a database with more specific detail.

The Lethal Crash Area section 508, shown in FIG. 16, can be used to calculate the LCA for the dive and glide types of crashes. For example, selecting the “Generate Lethal Crash Area” button will automatically calculate the LCAs based upon the aircraft inputs. In another example, the user can change the values to be different than the calculated ones, if tests are being conducted that a larger or smaller LCA would be generated.

The Failure Information section 510, shown in FIG. 16, allows for the user to specificity the percentages of each failure mode to be tested. For example, the percentages of all of the failure modes sum up to 100%. In the example shown, the option to “Bound Glide by FTS Time” can be selected to have a bounded glide failure. This option can further limit if the glide PCA to either when the aircraft glides into the ground, or if the aircraft glides for longer than the allowed FTS time. Having the bounded glide option deselected means that the glide PCA is only limited by how far the aircraft can glide before it contacts the ground. At high altitudes, this glide range can grow large and greatly increase computational time.

The interface can also have built in functions 512 to import select parts of the data from previous runs to enable reuse or modification. In the example shown in FIG. 16, the “Import Aircraft” button allows for the import of all of the data in the “Aircraft Information” section from a database. This enables one user to create a custom aircraft, run a test, and then share it with another user who can import just the aircraft to run a different test case. The “Import All” allows the user to take a previous test case file and import all of the inputs for the entire user interface. The “Export All” exports all of the data entered into the user interface. This exported data is stored in a file that can be shared and used to import the aircraft data, flight path, or entire flight path. The “Open Results” function allows the user to open previous run tests without having to rerun all of the risk calculations. This will open a folder navigation window that allows the user to browse to previously saved test results.

Further, an additional user interface 518 can be provided to enter the waypoints information for a specified flight path. The user can enter the latitude and longitude of the desired location, altitude, speed, and FTS time for each point along the flight. As shown for example in FIG. 17, a table 516 can be used to input the waypoint information, which works similar to a spreadsheet, with the ability to copy and paste. In this example, the waypoints latitude and longitude must be entered in decimal degree format (i.e. −76.568871, 38.203537), and the altitude is altitude above ground level. A minimum of two waypoints is required to run each test. While there is no limit on the number of waypoints that can be added, the increase in number of waypoints does increase the time to run the tool.

Further, the altitude, speed, and FTS time can affect the risk of the flight. As altitude increases, the PCA increases due to two effects. The first effect is that as the altitude increases the distance the aircraft can glide increases, thus growing the PCA. Increase altitude also gives additional time for turning to take place, which increases the PCA behind where the failure took place. Altitude only effects the PCA for the Glide/Dive and Rotorcraft Dive and Autorotation PCA. Altitude does not affect the FTS PCA. As the speed increases, the distance of travel following the failure increases, which increases the PCA. A higher cruising speed also lowers the time spent over the population areas, which decreases the risk in each individual cell. Increasing the FTS time greatly can increase the PCA size bounded by the FTS time. A larger PCA puts a larger area at risk.

In this example, the map 518 shown in FIG. 17 can be updated as waypoints are entered to visually show where the waypoints are located to allow the user to verify the location is correct. For example, the default visualization of the map can be a simplified road map, or changed using the drop-down menu below the map to display a satellite or hybrid map layout. Additionally, the map can be moved using a mouse and dragged or zoomed in or out by using the mouse wheel. In this example, the user also can also click on the map to manually add waypoints locations.

As shown in FIG. 17, the user interface can include buttons 520 to allow the user to modify the waypoints and run the tool. In this example, the “Clear Waypoints” option can clear all of the waypoint information previously entered into the table. The “Import Waypoints” takes the waypoint information from a previously exported test and imports the waypoints data into the user interface. The “Import All” imports all of the information from a previously exported test. Similarly, the “Export All” stores all of the information entered into the user interface into a file that can be shared or used again for a later test. The “Run QUADRA” button starts the QUADRA tool risk calculation, which can take several minutes to several hours depending on the size of the flight path.

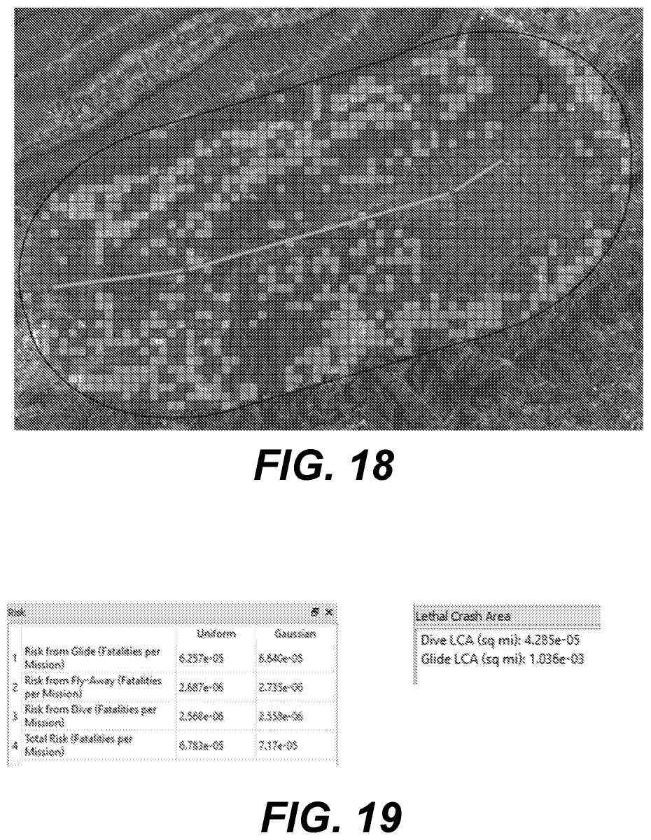

In response to completing the QUADRA risk calculation, the results display can be opened automatically, as shown for example in FIG. 18. In this example, a map showing the hazard area of the flight path is displayed, which is color coded to show the relative level of risk at any given location. The waypoints can be also marked and the flight path is shown, displayed over the hazard area. The user can select which failure mode and which information is displayed on the map. In this example, the user can also zoom in or out, or pan the map using a mouse.

For example, a breakdown of the risk values from each failure mode and the total risk is displayed as a table, shown in FIG. 19. The risk is given in both a uniform crash probability distribution, and a joint probabilistic model. Additional information, such as the lethal crash area for the glide and dive cases are given can also be displayed. The QUADRA tool can also save test results after a test case is run. The results file can be opened later without having to rerun the entire test again.

The flowchart in FIG. 15 show an example of the functions and operations of the components described herein. The components described herein can be embodied in hardware, software, or a combination of hardware and software. If embodied in software, each element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The computing environment 100 can include at least one processing circuit. Such a processing circuit can include, for example, one or more processors and one or more storage or memory devices coupled to a local interface. The local interface can include, for example, a data bus with an accompanying address/control bus or any other suitable bus structure. Similarly, a gateway can include at least one processing circuit. Such a processing circuit can include, for example, one or more processors and one or more storage or memory devices coupled to a local interface.

The storage or memory devices can store data or components that are executable by the processors of the processing circuit. For example, the flight path engine 110 and/or other components can be stored in one or more storage devices and be executable by one or more processors in the computing environment 100.

The flight path engine 110 and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including the flight path engine 110 and/or other components can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

1. A system for providing a quantitative risk assessment, comprising:
a computing device comprising at least one hardware processor; and
program instructions executable in the computing device that, when executed by the computing device, cause the computing device to:
obtain a nominal flight path of an aircraft;
calculate a potential crash area for a section of the nominal flight path based on a failure mode;
calculate a risk value based on population data of a geographical area traveled corresponding to the nominal flight path; and
display the calculated risk value plotted on a map of at least a section of the geographical area traveled corresponding to the nominal flight path.

2. The system of claim 1, wherein the section of the nominal flight path comprises one section of a plurality of sections, the nominal flight path connects at least two sequential waypoints, and the nominal flight path is divided into the plurality of sections based on each population cell traversed along the nominal flight path.

3. The system of claim 1, wherein the computing device is further configured to cause the computing device to sum the risk values for each population cell along the nominal flight path.

4. The system of claim 1, wherein the section of the nominal flight path comprises a length of a distance traveled across a population cell defined in the population data, and the potential crash area is based on a failure point along the nominal flight path at an entry point of the population cell.

5. The system of claim 1, wherein the computing device is further configured to calculate the risk value based on a probability of loss of an aircraft, wherein the probability of loss of the aircraft is adjusted for a time spent over a population cell for the section of the nominal flight path.

6. The system of claim 1, wherein the computing device is further configured to calculate the risk value based on truncated gaussian probability distribution applied to the potential crash area.

7. The system of claim 1, wherein the computing device is further configured to calculate the risk value based on a joint probability distribution, the joint probability distribution comprising an along-track distribution colinear to the section of the nominal flight path and an across-track distribution perpendicular to the section of nominal flight path.

8. The system of claim 1, wherein the computing device is further configured to calculate the risk value based on a bivariate joint distribution a function of radial and angular coordinates.

9. (canceled)

10. (canceled)

11. The system of claim 1, wherein, to calculate the potential crash area, the computing device is further configured to determine impact points based on maximum distances the aircraft could travel in all directions.

12-14. (canceled)

15. A non-transitory computer-readable medium embodying program code executable in a computing device, the program instructions being configured to cause the computing device to at least:
obtain a nominal flight path of an aircraft;
calculate a potential crash area for a section of the nominal flight path based on a failure mode;
calculate risk values based on a population data of a geographical area traveled corresponding to the nominal flight path; and
display the calculated risk values plotted on a map of at least a section of the geographical area traveled corresponding to the nominal flight path.

16. A method, comprising:
obtaining, in at least one computing device, a nominal flight path of an aircraft; calculating, in at least one computing device, a potential crash area for a section of the nominal flight path based on a failure mode;
calculating, in at least one computing device, risk values based on a population data of a geographical area traveled corresponding to the nominal flight path; and
displaying, using at least one computing device, calculated risk values plotted on a
map of at least a section of the geographical area traveled corresponding to the nominal flight path.

17. The method of claim 16, wherein the nominal flight path comprises at least two waypoints, wherein each waypoint of the at least two waypoints comprise location, altitude, speed, and flight termination system (FTS) time.

18. The method of claim 16, wherein the section of the nominal flight path comprises one section of a plurality of sections, the nominal flight path connects at least two sequential waypoints, and the nominal flight path is divided into the plurality of sections based on each population cell traversed along the nominal flight path.

19. The method of claim 16, further comprising summing the risk values for each population cell along the nominal flight path.

20. The method of claim 16, wherein the section of the nominal flight path comprises a length of a distance traveled across a population cell defined in the population data, and the potential crash area is based on a failure point along the nominal flight path at an entry point of the population cell.

21. The method of claim 16, further comprising calculating the risk value based on a probability of loss of an aircraft, wherein the probability of loss of the aircraft is adjusted for a time spent over a population cell for the section of the nominal flight path.

22. The method of claim 16, further comprising calculating the risk value based on truncated gaussian probability distribution applied to the potential crash area.

23. The method of claim 16, further comprising calculating the risk value based on a joint probability distribution, the joint probability distribution comprising an along-track distribution colinear to the section of the nominal flight path and an across-track distribution perpendicular to the section of nominal flight path.

24. The method of claim 16, further comprising calculating the risk value based on a bivariate joint distribution a function of radial and angular coordinates.

25. The method of claim 16, further comprising obtaining aircraft parameters comprising wingspan, weight, lift to drag ratio, maximum bank angle, thrust, glide speed, flight termination system (FTS) radius, drag coefficient, and cross-sectional area.

26-29. (canceled)
